(19) United States
(12) Patent Application Publication
(10) Pub. No.: US 2013/0023203 A1
(43) Pub. Date: Jan. 24, 2013

(54) TRANSPUTER

(71) Applicant: James Kakaire, Binghamton, NY (US)

(72) Inventor: James Kakaire, Binghamton, NY (US)

(21) Appl. No.: 13/638,236

(22) PCT Filed: Mar. 29, 2011
(86) PCT No.: PCT/US2011/030260

§ 371 Date: Sep. 28, 2012

Related U.S. Application Data
(60) Provisional application No. 61/341,291, filed on Mar. 29, 2010.

(51) Int. Cl. H04W 12/06; H04W 4/06

(52) U.S. Cl. 455/3.06; 455/427; 455/411

(57) ABSTRACT

A system for distributing signals from at least one land-based service provider and at least one satellite-based service provider to multiple auxiliary devices comprising: a wireless dish antenna for connection to a satellite or cell tower; a wireless access point coupled to the wireless dish antenna and a transputer coupled to the wireless access point. The transputer includes a circuit board, at least one processor, an operating system for interfacing with the processor, memory and physical resources, at least one transmitter for transmitting to auxiliary devices, at least one receiver for receiving from auxiliary devices, a repeater, a plurality of data ports, at least one hard drive, and memory all coupled to the processor, and network cards coupled to the data ports, including at least one network card coupled to the wireless access point to allow interaction with satellite, cell towers and/or land-based Internet.

### REFERENCE TO RELATED APPLICATIONS

This application claims one or more inventions which were disclosed in Provisional Application No. 61/347,291, filed Mar. 29, 2010, entitled “TRANSPUTER”. The benefit under 35 USC §119(e) of the United States provisional application is hereby claimed, and the aforementioned application is hereby incorporated herein by reference.

### BACKGROUND OF THE INVENTION

### Field of the Invention

The invention pertains to the field of land and satellite based systems. More particularly, the invention pertains to a transputer for obtaining services.

### SUMMARY OF THE INVENTION

A system for distributing signals from at least one land-based service provider and at least one satellite-based service provider to multiple auxiliary devices comprising: a wireless dish antenna for connection to a satellite or cell tower; a wireless access point coupled to the wireless dish antenna and a transputer coupled to the wireless access point. The transputer includes a circuit board, at least one processor on the circuit board, an operating system for running the processor, at least one transmitter coupled to the processor for transmitting to auxiliary devices, at least one receiver coupled to the processor for receiving from auxiliary devices, a repeater coupled to the processor, a plurality of data ports coupled to the processor, at least one hard drive coupled to the processor, random access memory coupled to the processor, and a plurality of network cards coupled to the plurality of data ports, including at least one network card coupled to the wireless access point to allow interaction with satellite, cell towers and or land-based Internet.

A method of providing data service using a mobile transputer device is also disclosed.

### BRIEF DESCRIPTION OF THE DRAWING

A complete understanding of this invention may be obtained by reference to the accompanying drawings, when taken in conjunction with the detailed description thereof in which:

FIG. 1 describes a graphical user interface used to operate the service.

FIG. 2 shows wired version of the satellite dish and how data is exchanged. The transputer works as a wireless access point unlike in the wireless embodiment, where the satellite dish works as the wireless access point. Outgoing data is sent from each of the transputers independently to cell towers, satellite or other without going through the satellite dish antenna.

FIG. 3 shows wireless version of a satellite dish. This version is programmable with a built-in access router. It interacts with devices as a wireless access point. It is loaded with a transmitter, repeater, amplifier and other devices that help it propagate data without signal degradation. Like the transputer in the wired version, the wireless version of dish antenna sends data out as well as the transputers depending on strength of transmitters and repeaters built in. The wireless dish antenna in this figure has an optional wire outlet.

FIG. 4 shows how the main transputers in both wired and wireless version authenticate other devices.

FIG. 5 shows a one button touch on a remote control or transputer that enables the system to get into desired mode in one step by means of software. Desired mode may be television, satellite, surveillance camera or other.

FIG. 6 shows a general data flow diagram where data source such as television service center, end users data, transmitters on land, in airplanes and water vessels provides data. Data from the transmitters locates airplanes and water vessels at all times. The data source also includes transmitters on land and water for environmental data transmitting to satellite and cell towers. Surveillance cameras transmit data directly to satellite dish antennas at a specified frequency to get downloaded and recorded in the transputer and attached external drives or computers. It includes a satellite, dish antenna, transputer and servers connecting to the Internet.

FIG. 7 describes data flow from source to destination

FIG. 8 shows a telephone Graphical User Interface.

FIG. 9 is a representation of phone and fax user interfaces linked to the address book that stores contacts on a transputer and synchronizes with server.

FIG. 10 is a continuation of FIG. 9 showing user interfaces for phone and fax.

FIG. 11 describes a process for setting up users to get service using a Transputer Mini (TM). If a user already has Internet access from another ISP, a TM is not used. Only the device address is used.

FIG. 12 shows how the service main menu operates. The menu is made of a graphical user interface abbreviated as GUI.

FIG. 13 shows a schematic of a transputer system board.

### DETAILED DESCRIPTION OF THE INVENTION

### Explanation of Reference Numbers in Figures

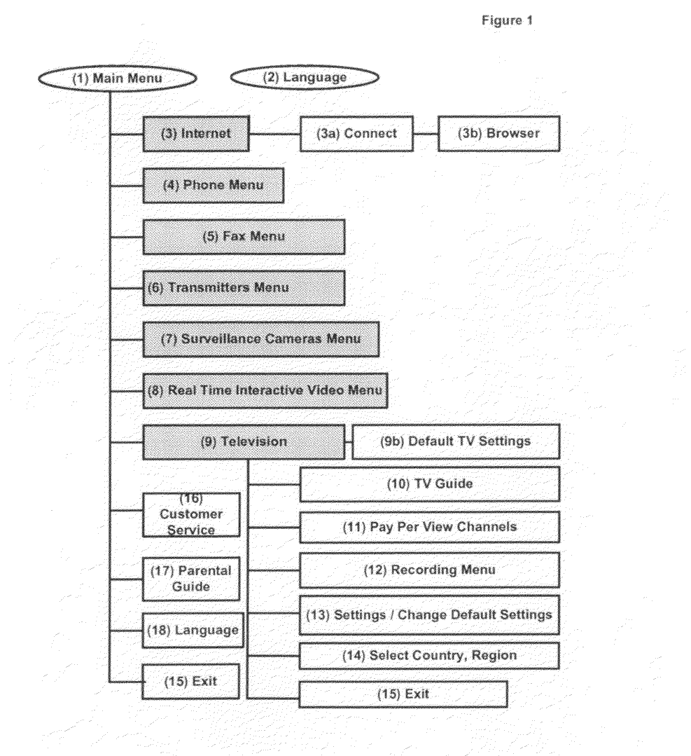

FIG. 1: Pressing of the Language button 2 on a remote control or transputer, provides all available languages to choose from. Pressing Menu 1, provides a menu that gives some of the seven options namely Internet Menu 3, Telephone menu 4, Fax Menu 5, Transmitters Menu 6, Surveillance camera Menu 7, Real Time Interactive Video Menu 8 and Television Menu 9.

Television menu 9, provides a button that resets to default television settings 9b, television guide 10, pay per view channels 11, recording menu 12, settings/change of default settings 13, Regional selection Option shows regions or countries available 14, and selecting a country or region displays available channels in that region. It also provides an exit option 15 on all submenus.

FIG. 1 further gives a customer service menu 16 used for payments and support, Parental Guide Menu for Internet and television 17, a language selection menu 18 and an option to exit main menu 15.

All options defaults to country where equipment is located and shows TV default channels. The reset button resets to location. Selecting TV Submenu 9, provides list of all participating countries and regions which can be updated by service provider at any time. Through TV menu or customer service menu, a user may request additional service such as adding or removing packages.

Some of the Customer Service Menu Options 16 are, Change Subscription Type, view your statement, pay your bill, Email Customer Service which is a built-in mail form and Customer Service Contact Phone Numbers. Settings, Change Default Settings 13 prompts user if they really want to change the settings.

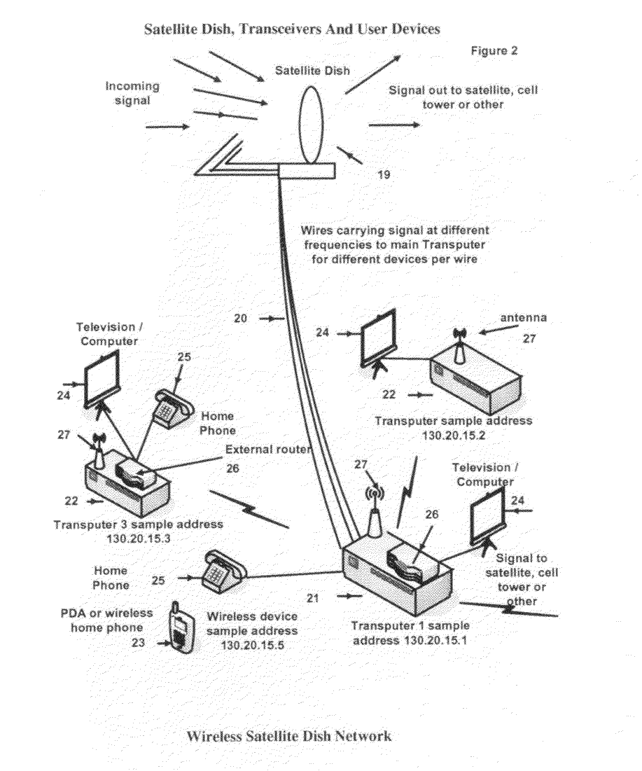

FIG. 2: Under FIG. 2, 19 is the wired dish antenna, 20 represents connecting wires, 21 is the main transputer and 22 are secondary transputers. Further, 23 is a wireless home phone, 24 represents devices such as computers and television, 25 is a phone plugged into a transputer 26 is a router or switch and 27 is an optional antenna.

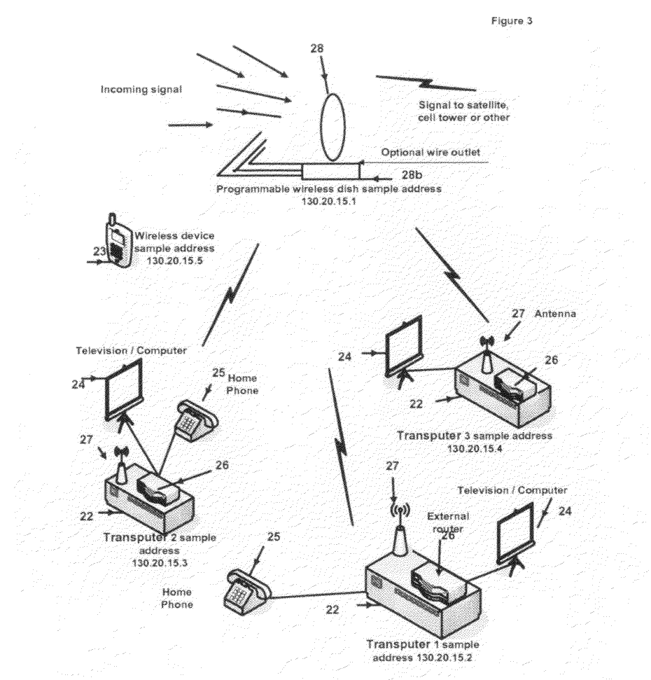

FIG. 3: Under FIG. 3, 28 is a wireless antenna utilized as a data access point, 22 represents transputers, 23 is a wireless home phone, 24 represents data devices such as computers and televisions, 25 is a telephone and 26 is a router or switch to which user data devices are connected. The router 26 optionally built inside a transputer.

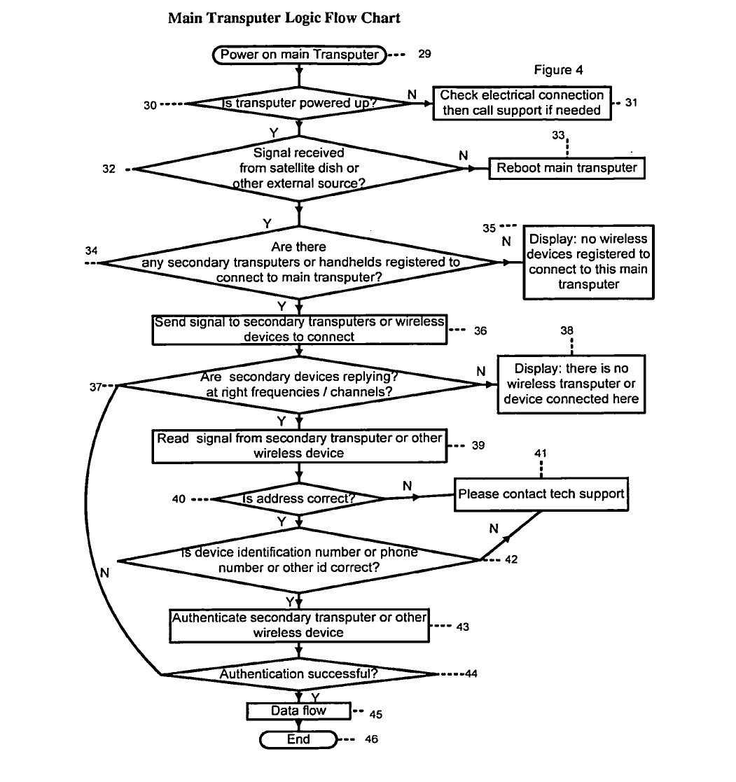

FIG. 4: Number 29 turns on the main transputer. If the transputer is not powered 30, user checks electrical connections 31, before calling technical support. If the computer is powered but signal is not received 32 from signal source, a message is displayed to indicate lack of connectivity and user reboots the transputer 33. If the signal is received, the transputer checks for secondary devices 34 registered to connect through it. If no devices are registered, it displays a message “no device” and the message disappears 35. If there are devices registered to connect 36, the transputer 37 checks frequency of incoming sine waves for matching hertz. If the devices reply with wrong frequencies or don't reply 38, the transputer displays “no devices connected”. If the replies are as configured 39, the transputer also checks an address 40. If the address is incorrect 41, the transputer displays “contact technical support”. If the address is right, the transputer checks all security 42 and if cleared 43, the secondary device is authenticated 44. Data flows 45 and the connection is closed when done 46.

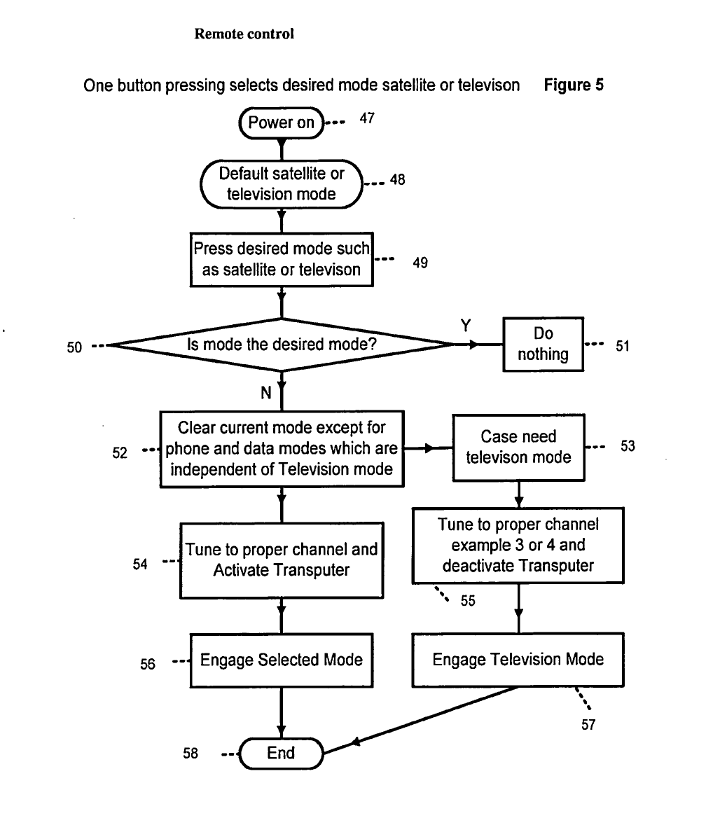

FIG. 5: Number 47 powers the transputer in addition to the transputer manual power button. The remote is programmed to control most standard television sets electrical power. The remote also controls the on onscreen keyboard and operates the graphical user interface though any USB or wireless keyboard used with a transputer. Number 48 is the default mode for television or satellite setting. At 49, mode of operation is changed and 50 checks the desired mode. If the mode is correct 51, nothing is done, else mode is cleared out of cache memory 52. If a user wants television mode 53, television is selected with default channel or last channel viewed 55 allowing channel setting to be changed 57. If no television mode such as phone or fax is selected at 52, the particular software is activated 54 and selected mode is engaged 56. In case of fax or phone text fields where numbers are entered, a module reads the input string and inserts it in a data structure for the fax or phone while read character is digit only. If character is a separator, it is skipped. Fax data text field saves contents as a file. Data files and text field data are all sent as files in the fax software and so are retrieved from anywhere as files and can be printed or forwarded to different destinations. 58 ends

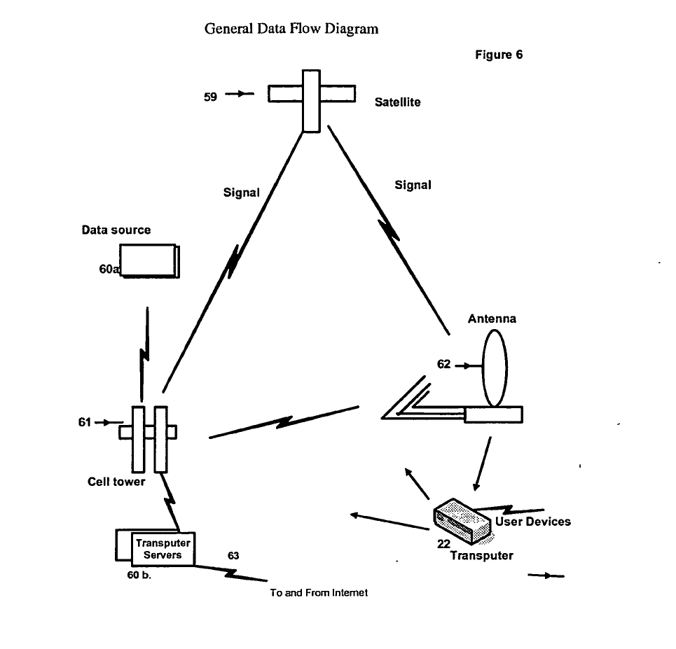

FIG. 6: Under FIG. 6, 59 is a space satellite, 60a represents data source such as data control center, transmitter and surveillance cameras, 60b represents servers connected to the tower via cable and 63 is a set of cables from the servers connecting to land based Internet. 61 is a cell tower, 62 is an antenna and 22 is a transputer. The servers connect to the towers that interact with the space satellite to downlink or uplink data and synchronize with Internet based servers.

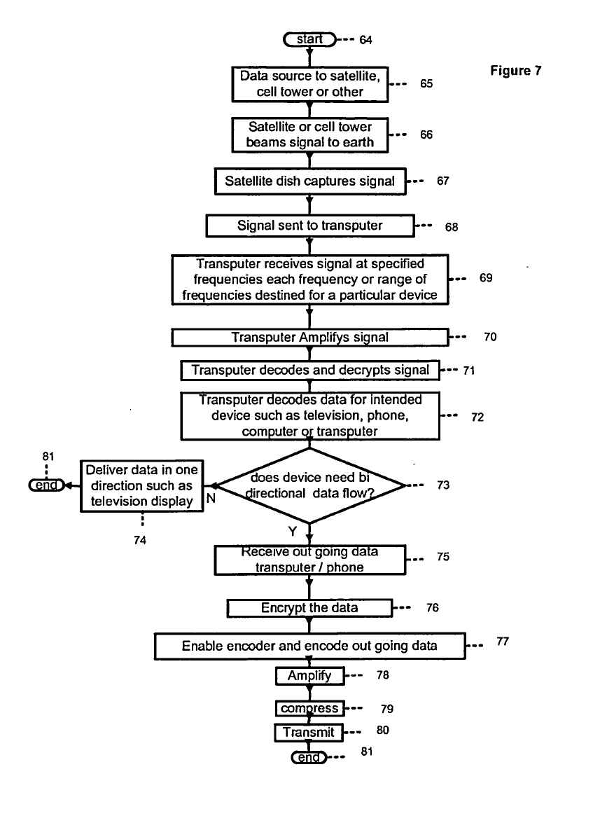

FIG. 7: FIG. 7 shows data flow from source to destination 64 start, 65 data source, 66 satellite or cell tower beams signal to Earth, 67 satellite antenna captures signal. 68 shows signal as sent to transputer. At 69, transputer receives signal at specified frequencies or range of frequencies designated for specific device. At 70, transputer amplifies signal. 71 decodes and decrypts of signal. 72 transputer sends data to intended device. 73 is a conditional selection. If device data is going out, selection goes to a phone or any outgoing data 75 else goes to a television 74. 74 is a one way data delivery of data. Phone 75 receives out going data from a transputer. 76 is data encryption. 77 modulates and encodes out going data. 78 Amplifies. 79 Compresses, 80 Transmits and 81 ends process.

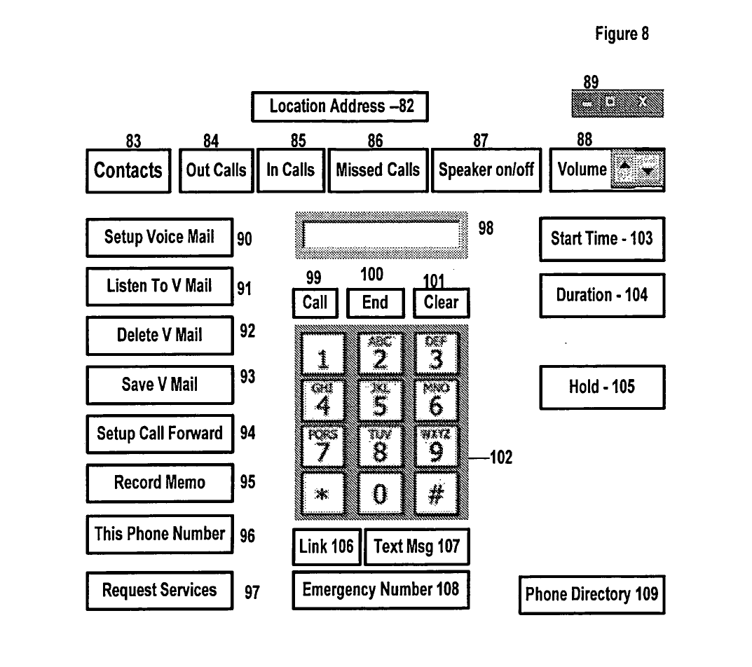

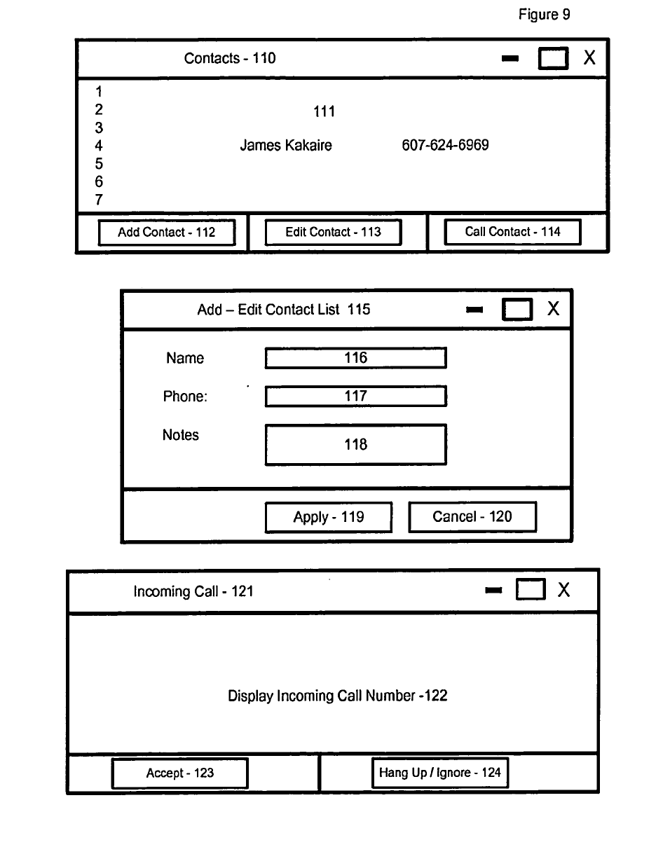

FIG. 8 shows an onscreen telephone user interface. Location of address where transputer is located is displayed on top of the telephone dial pad 82. When clicked, contacts button 83 shows all saved contacts and provides a popup window FIG. 9 (110-114) that allows user to edit the contacts list when the edit option is selected or add new when Add option is selected. These contacts are shared between the phone and fax. They are resident on transputer but synchronize with server to backup. Depending on configuration, synchronization can be manual or automatic. Choosing contacts shows names and highlighting a name provides option to call or cancel

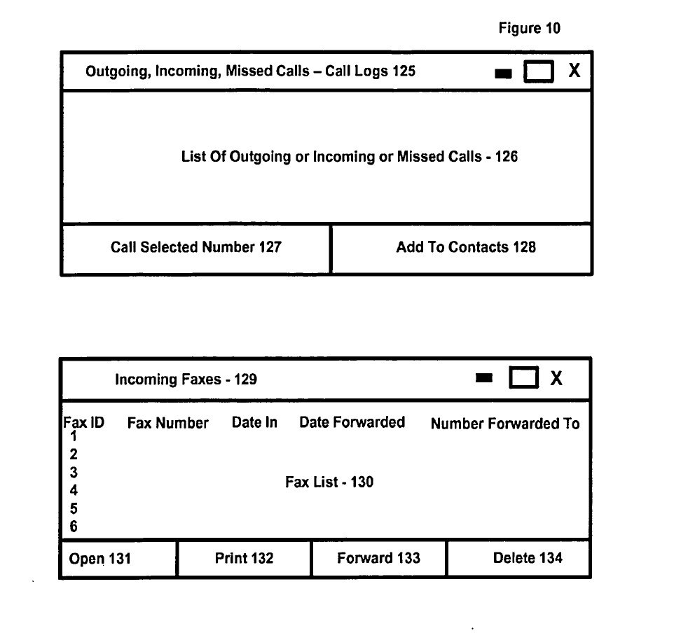

Outgoing calls 84 displays calls out, Incoming calls are displayed in a popup window and 85 accepts the incoming calls. 86 displays missed calls. Most buttons use dialogue boxes as in FIG. 10. 87 turns speaker on and off. If no external phone is connected FIGS. 2 and 3 (25) or no other external audio device connected, sound goes out through transputer speakers but sound comes in from an external device. Volume up or down 88, increases or decreases volume during live telephone Minimize, Maximize and close 89, minimizes, maximizes and closes the keypad phone interface.

Setup voice mail 90, allows multiple users to select their inboxes and setup voice mail using passwords if necessary. Listen to voice mail 91, allows users to select their particular mail box and listen to voicemail. Delete voice mail 92, deletes current message after listening to it. Save voice mail 93 saves the current voice message. Setup call forwarding 94 sets up call forwarding. Record Memo 95, allows recording of temporary message for callers. This Phone Number 96, displays information about the phone including phone number and area code. Request Services 97, requests for more services such as change of address where transputer is located, purchase of long distance minutes using credit card or other electronic means and more. It also provides request password reset and customer service phone number in case user needs help.

Number Text Box 98 displays input number while dialing. Call 99 places a call after entering a phone number into the Number Text Box 98. However, a user may also select a number from contacts, outgoing or incoming lists to make a phone call.

End 100, cancels a call, Clear 101 clears the Number Text Box 98.

Number keys 102, are the numbers 0 to 9, *, # used in making a call. Time 103, displays start time of a call. Duration 104, displays how long a call has lasted. Hold 105, puts a caller at the other end on hold and when configured, plays music. Link 106, allows 3-way calling. Text Msg 107, used to send and receive text messages. A text box pops out when the button is clicked. On click, Emergency Number 108, calls an emergency number specified. A confirmation dialogue box shows up for user to confirm whether they really want to call the emergency number. Phone Directory 109, links to Internet based phone books of choice that can be entered by user. Though default ones are specified.

FIG. 9 includes phone contacts title 110, contacts list 111 shows list of contacts, Add Contact 112, adds new contacts, Edit Contacts 113 edits existing contacts. Call 114 allows user to call a highlighted contact number.

FIG. 9 further shows Add/Edit Contact List 115 is a title of the dialogue box used to make entries, a text field 116 enters name, a text field 117 enters a phone number and a text area 118 is for notes. A button 119, effects entries and 120 cancels entry. A similar box is used to enter fax numbers as new entries. 121 is title of a dialogue box that accepts incoming calls with 122 displaying the incoming call. Button 123 accepts call and 124 cancels the incoming call.

FIG. 10 with title 125, represents three dialogue boxes showed as one because they are similar to each other. One is for outgoing calls, one for incoming calls and the third for missed calls. The dialogue boxes are displayed depending on what button is pressed on the onscreen key pad FIG. 8 (84, 85, 86). 126 is a list of calls available for users to select from and either directly places a call from there or adds to contacts. Button 127 calls the highlighted number and button 128 adds to contacts.

FIG. 10 further shows incoming digital faxes with title 129 showing fax. Fax list 130 displays all faxes saved pending opening. The open button 131, opens a fax, 132 prints a selected fax to a printer or fax machine. Forward 133 forwards the fax to another number that can either be selected from fax contacts or directly typed in. The last button Delete 134 deletes the fax from memory.

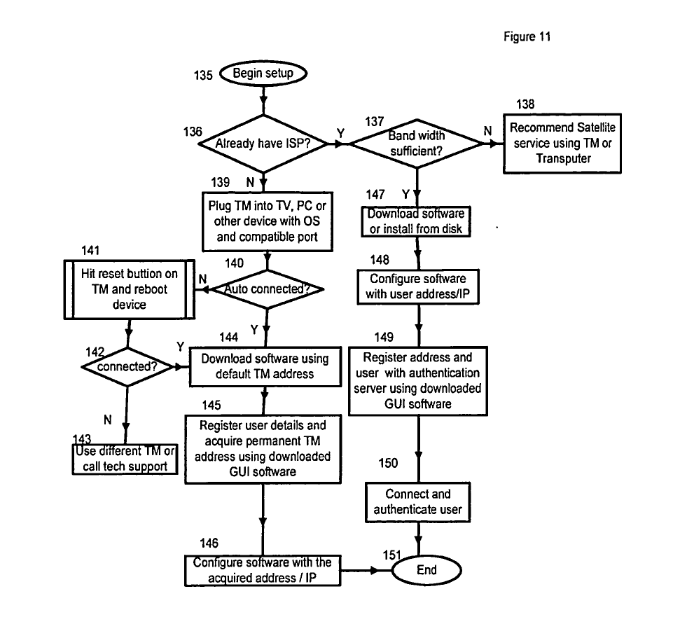

FIG. 11 Shows procedure for service setup which begins at step 135. Step 136 checks if user has Internet access with a different provider. If a user already has Internet, 137 checks to see if bandwidth is enough. If not enough, 138 recommends getting a Transputer Mini (TM). If the bandwidth 137 is enough for the services needed, the individual involved downloads software from website or installs from disk 147. Step 148 allows user to enter subscriber's details including payments and device address and hit a submit button within the software. This configures the device and registers the address 149 to have access to the services on servers 150. The end button 151 finishes. If device has no Internet connectivity from other providers 139, a Transputer Mini (TM) is used and plugged in a port such as Universal Serial Bus, High Definition Multimedia Interface or other slot to provide wireless connectivity and other services. The TM auto-connects to satellite or land based wireless antennas. Step 140, checks if TM is auto-connected. If not, individual presses a reset button 141 on the TM and if necessary reboots the device to establish a connection. Step 142 rechecks connectivity. If still not connected 143, a different TM is used or a call is placed to technical support. If a connection is established 144, software is downloaded over the TM default address. User details are submitted 145 and a permanent static address is obtained. The software is configured with the new IP address 146 and 151 ends.

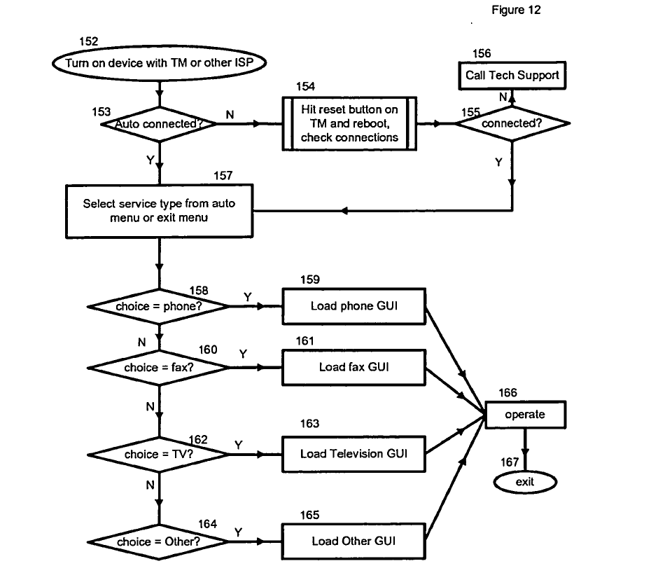

FIG. 12 shows how the service menu is used. Step 152 powers the device. Step 153 to 156 checks connectivity. If connected, step 157 displays main menu providing choices 158,160,162 and 164 with corresponding user interfaces 159, 161, 163 and 165. Step 166 is normal operation and 167 exits.

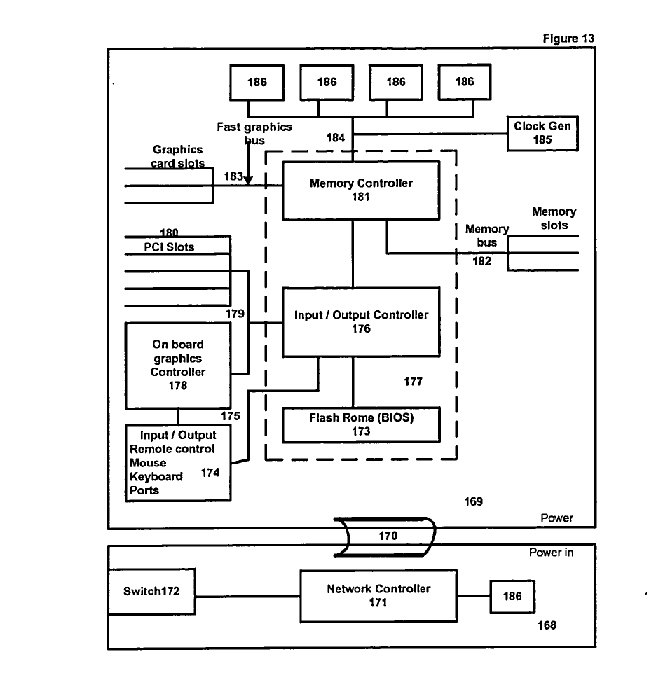

FIG. 13 shows a schematic of a transputer system board. The transputer system board as shown in FIG. 13 is made up of a small circuit board 168 and a bigger circuit board 169 joined by connector cables 170. Malfunction of one board may not affect functionality of the other. The small board 168 hosts a network controller bridge 171 and a network switch 172. The network switch 172 provides at least three slots—one for coax cable connection, a second slot for Ethernet wireless connection that provides a local area network for other devices such as laptops to connect through it and a third slot for a satellite input/output with an antenna coupled to a receiver, transmitter, repeater, noise filter for the wireless signal, a modulator and an encoder for converting data formats. Data out includes but is not limited to coax, HDMI, USB, component, phone jack and audio.

The bigger circuit board 169, hosts Flash Read Only Memory 173 with a remotely upgradeable BIOS, input/output ports 174 coupled via cables 175 to an input/output controller bridge 176 in an internal bus 177. The input/output controller is also known as the south bridge is also linked to the on-board graphics controller 178, PCI bus 179, with PCI and other expansion slots 180 and IDE (hard drives).

A north bridge 181 which also lies in the internal bus, connects with the memory bus 182 linking cache memory, random access memory and a high speed graphics bus 183 such as PCI express that provides graphics card slots. The north bridge 181 is also connected to the processor bus 184 which links the clock 185 and multiple processors 186 to all components. The processor 186 on-board 168 is optional.

### Description of the System

The system combines land and satellite based service from more than one service providers to simplify access to services. It enables devices already with Internet service from one provider to obtain other services such as television, phone and fax from a different provider. The system allows subscribers to temporarily move their service from one location to another without relocating the service.

This is accomplished by a transputer, transputer mini and antennas. Subscribed services are also accessible over an existing Internet connection from a different provider.

Service in this application refers to any one or combination of Internet service, television service, telephone service, fax service, real time video, surveillance camera service or transmitter data collection which are collected over different wires and frequencies as they enter processors. However, transputers have computing capabilities like that of regular computers.

Device may mean transputer, transputer mini, television set, computer, mobile phone or other.

A processor in this application refers to a data processing chip which receives data via wires and electronic circuit and processes it according to instructions.

Transputer and transputer mini are detailed under the operation section.

Unlike wireless systems that provide services separately, the present invention enables access to land based Internet servers in addition to space satellites and cell towers. This system provides television, wireless phone, surveillance camera data, real time video, fax, transmitter data collection and computer data to be received. Outgoing data includes, video, fax and voice. In addition, it connects to the Internet with a browser and processes data. The transputer provides bidirectional and inter network communication instead of receivers used with some satellite based television systems.

The present invention allows for wireless distribution of signals from within a building. In one embodiment, a wireless dish with built-in transputer is located outside. In another embodiment, a main transputer indoors connected by wires, distributes data wirelessly to other transputers connected by addressing. A built-in Ethernet wireless router provides connectivity to other networked devices. This wireless combination eliminates the need for drilling through walls to run wires.

In available wireless systems, some rooms of a building where a customer would want to place a television may not be accessible with the receivers that are based on drilling through walls. Wireless distribution of data within a building, makes the system of the present invention cost effective.

In some systems, remote controls are not user friendly when satellite signal is lost for any reason. Several steps have to be taken to restore satellite mode. A one step button restores television mode and vice versa in this invention.

Using a button on remote control or transputer; TV mode turns off all transputer functionality but lets power flow through transputer such that TV works without pressing several buttons. Satellite mode connects to the satellite by pressing one button as shown in the flow chart of FIG. 5.

This is accomplished by means of software that issues commands to reset all operations to satellite mode, TV mode or defaults to a choice of interest.

For the wireless programmable dish with a built-in transputer as shown in FIG. 3, multiple user devices can be connected to one dish without any wires, but by an addressing mechanism. Similarly, the main transputer in the other embodiment gets data through wires and then avails data to other devices. Best of all, the system provides services without telephone poles and wires on the streets. An optional wire outlet is built into the wireless satellite antenna to allow basement floors to receive signals that wouldn't otherwise.

Each of the transputers inside the buildings receives data from the dish antenna but sends out going data directly without sending it through the dish antenna outside.

For broadcast data via satellite where a User Datagram Protocol (UDP) is used other than a Transmission Control Protocol (TCP), extra bits are added to packets to make it unusable for non-subscribers and are removed by application at the receiving end.

Many different devices are wirelessly connected to the transputers, unlike in the satellite receiver based television where television receivers are restricted to a few wired televisions.

With a solar panel, remotely located users may be able to get a wireless home phone, Internet and television without electricity from major companies.

Many people now days don't subscribe to land line phones. Unlike existing systems that track location of dishes by land phone lines, a dish or transputer with an address such as Internet Protocol (IP), can be easily tracked wirelessly and provide useful information such as location and number of devices connected to the dish or main transputer since all transputers used are addressed. Service administration is remotely carried out by a service provider. The present invention also enables a user to log on from a remote location and manage their data.

The present invention enables real time electronic collection of climatic or weather data from environmental data delivery transmitters on land or large water bodies for analysis and storage. The present invention also enables collection of data from surveillance cameras and data from moving objects such as airplanes into transputers via antennas.

Unlike other technologies, the transputer uses a wireless card with Ethernet ports that allows it to connect to any Internet service provider and a card specifically for satellite connection. This enables it to be used by any company providing service.

The transputer allows synchronization of files with provider's servers and this makes access to data from anywhere easy for transputer owners using mobile devices. The subscribers remotely access data and subscribed service using authenticated devices.

The authentication server keeps log of number of devices in use at a time for each subscription. The number of mobile devices that connects depends on terms.

Depending on subscription, user configures transputer to do auto or manual synchronization of data including incoming and outgoing faxes.

Transputer owners get access to their television, telephone and fax subscriptions from anywhere there is Internet connection or via satellite on a Transputer Mini (TM).

The transputer works with any wireless or USB keyboard in addition to the onscreen keyboard. It has full computer capability with operating system of choice and works with any display with compatible ports. The transputer has functionality of a computer so one can download anything they normally download onto a computer using a browser on a network or from a disk. The transputer is configurable to auto or manual update software whenever there are updates available.

The remote control, on screen keyboard and transputer buttons control all functions on a transputer. However, it is preloaded with drivers of the most common keyboards such that any keyboard with a USB port or wireless keyboard works automatically.

Transputers on a network may share application software instead of installing them on local drives. This speeds up processing time and frees storage space.

The transputer system utilizes servers that links satellite based broadcasting and Internet based broadcasting via cables such as fiber optics. This enables users to have access to their service remotely over an Internet connection or using a portable transputer mini that plugs into ports such as USB, HDMI or a network slot on a device.

Land based satellites interact with space satellites to uplink and downlink data. In turn, the land based satellites interact with servers and transputers.

The transputer is used with any Internet service provider to connect to the Internet via a wireless Ethernet card and coaxial input. It connects to satellite antenna via a satellite card. It works with any display with compatible ports for video conferencing when a camera is connected.

Any address based device such as mobile phone, computer or television is authenticated to have access to services from any where.

The system joins satellite and Internet traffic to use existing cabling in city environment as well as wireless satellite connections for rural users.

A transputer and transputer mini works with satellites to provide services.

Transputer servers connected to the Internet by cables, shares the same data with servers that uplinks data to satellite via antennas on towers and downlink from space satellite to Internet connected servers. The transputer mini (TM), provides mobile access to services. In addition, any other device with an Internet address such as Internet Protocol and an operating system is authenticated to service after registration of the device address in the authentication servers. Subnets are setup in different regions to identify origin of the Internet address connecting to servers for service.

A satellite dish antenna with two versions: wired as shown in FIG. 2 and wireless FIG. 3 with a built-in router 28b receives signals and uses a wireless mechanism FIG. 3 or wires FIG. 2 20 to transfer signal from space satellites 59, cell towers 61, surveillance cameras and transmitters 60 to transputer(s) 63 as shown in FIG. 6. Fax, real time video, voice and data are also transferred back from transputers to cell nodes via antennas or space satellites.

For the wired version of this system as shown in FIG. 2, there are two options. The satellite dish 19 collects signals and passes the signals onto the main transputer 21 through wires 20. A wire(s) 20 from the satellite dish antenna 19 is set to pass signals to a particular processor chip that decodes only specific frequencies. That is, wire(s) 20 sends signals to a chip that decodes the signals into TV programming. Another wire(s) 20 from the antenna 19 runs along the first wire and sends a signal to a different chip within the transputer for the transputer to decode the signals into data for computers or televisions 24. Another wire(s) gets to the transputer and data from that range of frequencies, is decoded into voice for a home telephone 25 and so on. Since there is a processor chip for each wire(s) and frequency range, all devices that is, television, computer, phone, fax, surveillance cameras, real time video and transmitters work independently.

Alternatively, under FIG. 2, data from the satellite dish antenna 19 goes through one wire 20 to the main transputer 21. The transputer 21 then filters out noise or unwanted data, and splits the signal according to frequency, amplifies, decodes and sends it to user devices or wirelessly to other transputers 22 in the building.

A transputer 21 is made to receive TV programming signal, Internet data, voice, fax, surveillance camera, real time video, transmitters or all of the above from a satellite dish antenna 19. This transputer with an address such as Internet Protocol (IP), allows entry of addresses of other devices that connects through it wirelessly.

These addresses are entered via a built-in mini keyboard, an externally connected full size keyboard through a port such as Universal Serial Bus (USB), or an externally connected device that one logs on and synchronizes intended addresses of devices with the ones in the transputer to allow other devices to connect to the transputer and allow removal of devices that are discontinued.

The main transputer in this case 21 works like a wireless access point, but restricts connectivity only to devices whose addresses are entered into the main transputer or devices physically connected to the transputer such as a router or switch for computer(s). The main transputer is loaded with a repeater that amplifies the signal to prevent degradation during wireless transmission.

The main transputer 21 also works as a subnet on a network from which similar addresses are extended to other transputers 22 in the vicinity by means of addressing such as Internet Protocol (IP) or other means capable of wirelessly authenticating, and receiving and sending a signal and authenticates as described in steps 29-46 of FIG. 4. It is by this addressing mechanism that the main transputer is identified when it transmits data. However, transputers may also be identified by phone number, system identification number (SIN) or physical addresses.

When secondary transputers 22, whose addresses are stored in the main transputer 21 are turned on, they look for a signal from the main transputer, to supply their address to the main transputer 21 for authentication and the main transputer 21 verifies the address and other data and then allows connection and data exchange.

The transputers 21, 22, and router 28b are made to transmit data so that they can allow interactivity needed by the Internet connected devices.

To allow for communication between a transputer, computers 24 and mobile devices such as PDA's 23, routers or switches 26 are physically connected to a transputer 22. The router or switch 26 connected to a transputer is wireless with Ethernet ports. On the way in, the transputer decodes data and encodes it on the way out as shown in FIG. 7, steps 68-72. Some or all of the data is encrypted and compressed to maximize data security and minimize transmission time as shown in FIG. 7, steps 75-81. The main transputer 21 has a built-in router that connects other devices wirelessly or through Ethernet ports and a coaxial input.

The transputers 21, 22 and router 28b have one, two or more processor chips for decoding and encoding at different frequencies and at least three modes of television 24, Internet 24, real time video, surveillance camera, transmitter and telephone 25. The phone mode is always on by default. The onscreen Graphical User Interface with a remote control or button on the transputer are used to select other modes or type of service. Each type of service is independent of the others.

A call placed from a wireless home phone 23, 25 is identified by cell towers 61 or satellite 59 by phone number. A call placed to a wireless home phone is received by all of the transputers in all rooms since the phone number is configured in all transputers.

One frequency may be used for a zero value in binary and another frequency may be used for a one in binary data format.

To help reduce interference and let multiple devices use the same wireless connection simultaneously, the system may frequent hop or jump between frequencies.

A transputer 21, 22 and router 28b sends outgoing data at one frequency or a range of frequencies and receives data at different frequencies in order to distinguish between the incoming data. The transputer 21, 22 assigns a unique code to data on encoding and it is this unique code that is used to decode the data at destination.

The wireless version of dish antenna 28 is powered by solar rechargeable batteries. However, electricity, solar panels or any other kind of energy may be used to power the dish. The dish detects low battery by means of a sensor and sends signal to the television or computer to advise the change of battery.

The wireless satellite dish 28 takes addresses of transputer(s) to connect to it and stores the addresses in memory. Addresses are either entered via a water proofed mini keyboard mounted on the dish antenna or via an externally connected device through a slot or data port such as USB. The dish continually transmits a signal.

The transputers 22 receive signals from the dish antenna 28 and decodes the signals according to frequency and then distributes the signals to other electronic devices connected to the transputer such as televisions 24, phones 25, routers or switches 26 for computers and fax machines.

The wireless dish 28 with built-in transputer 28b or main transputer 21 in the wired version, periodically transmits data such as system identification number, addresses of devices connected to it and phone number to a service provider for identification. The physical street address where the dish is located and number of transputers or devices connected to the satellite dish or main transputer in the wired version can also be transmitted to the service provider, since all transputers are addressed and any activated port on transputer is reported.

A service provider logs in remotely and administers the transputer 21, 22, trouble shooting and upgrading any software. Similarly, a user logs in remotely for access to recorded videos, faxes or current camera recordings.

In the case of a regular non-interactive dish antenna, wires are extended to the transputer and the transputer wirelessly distributes data to other addressed devices.

### Operation

A transputer 21, 22 comprises of a circuit board, at least one processor, an operating system, at least one transmitter, at least one receiver, a repeater, data ports, at least one hard drive, random access memory, a clock, internal speakers, a filter for eliminating noise from the wireless signal and network cards coupled to an antenna to allow interaction with satellite, cell towers and or land based Internet.

The transputer system board as shown in FIG. 13 is made up of a small circuit board 168 and a bigger circuit board 169 joined by connector cables 170. Malfunction of one board may not affect functionality of the other. The small board 168 hosts a network controller bridge 171 and a network switch 172. The network switch 172 provides at least three slots—one for coax cable connection, a second slot for Ethernet wireless connection that provides a local area network for other devices such as laptops to connect through it and a third slot for a satellite input/output with an antenna coupled to a receiver, transmitter, repeater, noise filter for the wireless signal, a modulator and an encoder for converting data formats. Data out includes but is not limited to coax, HDMI, USB, component, phone jack and audio.

The network switch 172 factory setting defaults to wireless Ethernet to work like any computer. Satellite mode is remotely activated when there is satellite subscription. When satellite service is discontinued, wireless Ethernet automatically engages. Coax cable works upon physically plugging in the cable.

The bigger circuit board 169, hosts Flash Read Only Memory 173 with a remotely upgradeable BIOS, input/output ports 174 coupled via cables 175 to an input/output controller bridge 176 in an internal bus 177. The input/output controller is also known as the south bridge is also linked to the on-board graphics controller 178, PCI bus 179, with PCI and other expansion slots 180 and IDE (hard drives).

A north bridge 181 which also lies in the internal bus, connects with the memory bus 182 linking cache memory, random access memory and a high speed graphics bus 183 such as PCI express that provides graphics card slots. The north bridge 181 is also connected to the processor bus 184 which links the clock 185 and multiple processors 186 to all components. The processor 186 on-board 168 is optional.

The transputer circuit or system board electrically connects all components and hosts most of the small components on-board. Some internal components are compatible with desktop computer internal components. These include but are note limited to power supply, heat sinks, cooling fans, chipset for routing data between the component buses, a clock generator for synchronizing the components, speakers, herd drives, CD and DVD drives or Blue Ray drive, power connectors, Integrated Drive Electronics (IDE) connectors and other connectors.

The board has two video card slots to allow connection of two displays concurrently. Each low power processing unit (CPU) 185 has a heat sink and a cooling fan or an alternative cooling system. The primary hard drive is set as master and secondary drives as slaves using jumpers. Extra drives are added by installing an expansion card with IDE connectors. Slots are reserved for both half and full size expansion boards to allow for serial ports, parallel ports and other multiple function input/output controller boards.

The television circuitry and software converts broadcast from region to region and television standard such as NTSC to video standard such as VGA or SVGA for non-television monitor displays. It allows more than one window to display on the screen at the same time to view more than one event. The system provides choices to select type of display as television set or computer monitor during configuration.

One wireless card connects to land based satellite towers 61 or space satellite 59 or an antenna located outside a building 62.

The second Ethernet wireless network card with a coaxial input connects to any other Internet service provider including cable. The network cards are installed on a circuit board with a communication processing chip programmed to enable connectivity. While the user has access to satellite services, instructions in the chip enables the satellite network card. Once service is discontinued by the service provider, the satellite card is automatically disabled and instructions enable the other card. The other card is unusable when not enabled by the service provider through the chip.

Speaker outlets, allow connection of external speakers. A universal video card installed in a transputer 21, 22, enables it to work with television sets and standard computer monitors 24. The transputer 21, 22 receives signals at different frequencies and decodes it to suit intended devices. A transputer 21, 22 allows bidirectional flow of data and enables addressing for wireless networking of devices and multi device usage. Though the transputer connects to the Internet with a browser and processes data, it also allows computers to connect through it and get to the Internet.

The remote control is designed with a left and a right mouse button to enable wireless mouse capabilities. The buttons are sunken in to prevent damage. The remote control is similar to a television remote but may also control the onscreen keyboard and graphical user interface.

A transputer 22 defaults to a Graphical User Interface menu FIG. 1 when powered. However, it is configurable to default to a plain desktop with icons including the menu icon.

The multiprocessor transputer 21, 22 connects to television or computer monitor 24 via a port and data cable. It allows concurrent operation of more than one service at a time.

To accommodate new and old technologies, transputer ports includes HDMI, DVI, VGA, Component, USB, Coaxial and Optical ports for video, audio and game consoles. The HDMI Ports are used to transfer High Definition audio-video signals while USB enables functions such as transferring recorded content from hard drive.

The transputer 21, 22 provides bidirectional data flow which enables all service types to be processed visualized on a television screen or any display 24 attached to a transputer 21, 22.

Utilizing wireless network connectivity and addressing such as Internet Protocol the transputer 21, 22 distributes incoming data wirelessly to other devices whose address are entered into or physically connected to transputer with wires. Connections defaults to land based satellites are configured based on location of Transputer or TM.

The transputer allows installation of applications including word processors and browsers so that a person without a computer can carry out computing functions while allowing saving of data to a hard drive within the transputer or a remote server operated by service provider. This gives user access from a remotely connected device to view and manage processes by authentication while allowing service provider access to administer service related processes;

The transputer provides data service whereby incoming data for, Internet, television, phone, fax and other data is split into particular type basing on frequency or flags. It allows computers or other devices whose addresses are entered into transputer and also computers that are directly connected by wires or Ethernet to connect through to the Internet.

The transputer utilizes cache memory that is set aside for real time video, games or data such that data is downloaded and held in cache allowing user to interact with the cached data instead of incoming data. This reduces latency problems. It also enables forwarding or rewinding of television programs. Cached data enables recording of full program on a hard drive when a user starts recording after the show is started. This is accomplished by storing each television program from its beginning and deleting it at end of programming if not used.

Drivers for peripherals such as printers, fax machines or scanners, are preinstalled on a transputer 21, 22 to print, fax or scan documents. Drivers and any other software are upgraded and new ones installed remotely.

Service provider provides document storage on server for users.

The transputer 21, 22 has an onscreen keyboard but provides port for external keyboards and standard wireless keyboards are used with the transputer.

Transputer provides audio in and out device ports to allow for plug and play external audio devices to be used. Bluetooth technology is enabled in transputer for wireless device access.

At setup, an authorized user enters address and selects default country or region into transputer 21,22. Residential or office address provides two options one standard format of Number, street, city, state/province and code whereas the other provides description of address as a text box in case there is no standardized address.

Powering on of transputer 21,22 defaults to country where equipment is located.

All countries and regions are pre-programmed into the transputer 21,22 and linked to programs aired in those countries. Each country is assigned a numerical value which is then converted to binary format during computation. It is this value that identifies a country when a user selects one. The same applies to regions.

The transputer 21, 22 connected to a television or monitor 24 displays ongoing processes and allows a user to select a country and access channels specific to a selected country using an on screen menu or keypad. The channels are updated as needed by service provider and user can save channels as favorites while viewing or from the main menu.

The present invention provides digital television where data packets are flagged to identify data type, country and region television broadcast is from such that when a user selects a country or region, they get access to channels filtered specific to selected country or region. Region means two or more countries and it also refers to a specific area within a country. Regions allows service providers to insert advertisements specific to regions. The channels are updated as needed by service provider and displayed in a TV Guide.

A single touch button on remote control or transputer 21,22 allows user to select a language in case language gets mixed. When a language is selected, a user can either change settings, select a country to get programming from or reset to default settings. Language is also selected from the main menu 18.

Graphical user interfaces are used on transputer 21, 22 and they display on television set or monitor 24 connected to transputer 21, 22 to manipulate all the seven functions offered by transputer. Each function namely television, Internet, phone, fax, real time interactive video, transmitter and surveillance camera has its own graphical user interface. The main menu has a computer mode that turns the GUI into an icon. The transputer software is configured to default to GUI or to computer with an icon.

The onscreen keypad telephone interface contact numbers are locally stored in the same address book with fax contacts on the transputer 21, 22 but are configurable to synchronize with a provider's servers automatically or manually. The address book includes four views selectable by radio buttons. These are work, personal, other and all. Contact information includes some combination of any of the following: First Name, Last Name, e-mail, Address, Phone, Fax, company and title.

A graphical user interface displays a phone key pad FIG. 8 that loads from a transputer 21, 22 when one selects to activate the phone or when there is an incoming call. It displays on a television set or monitor screen 24 connected to a transputer 21, 22. This key pad allows entry of contacts which are saved on the transputer but periodically synchronizes with a service provider server for backup. It is used for all phone functions.

A user may select contacts and selects a number and selects call or can type it if desired. Similarly, user may select a number from outgoing, incoming or missed calls.

An incoming call provides a popup FIG. 9(122) showing the incoming call number and provides an option to accept or cancel. Once canceled, it appears under the missed calls log. From missed calls, incoming calls and outgoing calls logs, one can highlight a number and select call or add to contacts. Similarly, one may right click on number and get a menu that allows add to contacts.

Software looks at country code digits by means of tokenized strings to determine whether call is being placed locally or long distance. If the call is long distance, a user is advised to purchase long distance minutes.

Changing an address used for an emergency number is processed through onscreen keypad telephone interface. This alerts customer service which follows a procedure to change address on servers.

Each transputer 21, 22 is provided with an electronic serial number programmed into it as a distinguishing feature. It gets an address such as Internet Protocol (IP) for networking. A phone number also connects the transputers 21, 22.

Each phone line 23, 25 uses at least two frequencies for talking and listening.

A phone 23, 25 connected to a transputer 21, 22 dials out through the transputer and it is the main transputer 21 that is identified by the service provider. The phone number also displays for further identification to other phones.

Fax software receives faxes and saves them in an in-fax folder on hard drive as files. The faxes can be viewed from any screen connected to the transputer and can be printed to an externally connected printer or fax machine depending on user configuration and selection. Files are sent to the out-fax folder in the fax software from a scanner. Files saved on hard drive are also moved to out-fax folder by right clicking or using a menu in the fax software. The fax software then reads from the out-fax.

When a fax is received, a popup window comes up to inform user of a new fax. This happens when television or any other display 24 is powered on. This popup window persists until the user closes it or attends to the fax. The user can choose to print, read, save or delete the fax with confirmation.

All saved faxes show up in a list when a user presses fax on a remote control or transputer 21, 22. They are automatically arranged chronologically and one can scroll to date and fax number of interest. Like in the phone system, contact fax numbers are also saved and can be used to send faxes by highlighting them then select send fax.

Faxes are sorted and searched by fax number, name, company or date. They are remotely accessible and can be digitally forwarded at anytime.

Utilizing a menu, a user configures fax software to print directly to a fax machine or printer each time a fax comes through while saving a copy to hard drive as a file. Fax software is configurable to allow popup windows to show up periodically as reminders for new faxes.

When a transputer 21, 22 is off, incoming faxes are stored at provider's server. When the transputer 21, 22 is turned on, the fax server is alerted and faxes are sent to the transputer 21, 22.

Incoming faxes resides on transputer 21, 22 as files in an in-fax folder and outgoing faxes are saved in the out-fax folder. A user can login with a mobile device from anywhere and get documents on the transputer. The documents also synch with fax servers.

Multiple fax numbers receive incoming faxes individually but are configurable to redirect to one fax number with simple code such as,

For all incoming faxes Do
Receive fax at server

check database for validity and numbers related to the intended fax number,

While fax number is valid Do
Is the fax number assigned a redirection number?
   If yes, insert redirection number as new destination number
   Send fax to the redirection number, confirm delivery

Else send fax to original number entered, confirm delivery
Else error out: the fax number is invalid End

Printing and all other connections are enabled on a transputer via ports and wireless connectivity. Bluetooth technology is enabled for blue tooth devices.

Transputers 21, 22 and router 28b may have battery backups to allow them operate in absence of electricity thereby enabling telephone usage in emergency situations.

When powered, the secondary transputer 22 provides its identification number and address to the main transputer 21.

Powering up the main transputer 21 connected to dish antenna 19, it looks for responses from devices with addresses in its storage. A device whose address is not in the main transputer 21 and whose communication frequency range is different is not authenticated to receive service. This main transputer 21 then distributes signal wirelessly to the secondary transputers 22. The secondary transputers 22 also feed televisions 24, phones 25 and routers or switches 26 for computers. Similarly, transputers transmit data out to cell towers 61, space satellites 59 and other destinations.

The main transputer 21 exchanges data with other transputers 22 within a building wirelessly, but devices such as televisions, phones and others may be connected to it or the other transputers 22 directly using wires.

The transputer 22 as shown in FIG. 3 with the wireless version of satellite dish antenna may have a repeater (not shown), both a low power transmitter for low altitude data transmission that enables signal to propagate to cell towers, and a high power transmitter to enable transmission to space satellites. One or both transmitters may be used with radio or microwaves.

Transmitters built into transputers 21, 22 and router 28b may be made with specifications of low frequency of 3-30 MHz and one above 30 MHz.

The transputer 21, 22 receives outgoing data from devices such as phones computers, fax machines or handhelds via internal or external routers 26. The transputers 21 and router 28b encode, amplify, and encrypt the data when necessary, and transmit the data to cell towers 61, space satellites 59 or other mediums that further propagates data to final destination as shown in FIG. 6.

Transputers 21 and router 28b receives incoming data, decodes, amplifies, and distributes the incoming data to user devices in the vicinity through steps 29-46 as shown in FIG. 4 as discussed above.

The transputer 21, 22, caches the last television channel viewed in cache memory and provides it whenever the user turns on TV or wants to retreat after changing to a different channel.

The wireless satellite dish antenna 28 with a built-in transputer 28b and memory serves as a subnet providing addresses for secondary equipment whose addresses are stored in the transputer.

The wireless dish antenna 28 with a built-in router 28b and main transputer in wired version 21 works like wireless access point and distributes signal to secondary electronic devices such as transputers 22 whose addresses are stored in the main transputers and whose communication frequency range is specified. The antenna then transmits data to secondary transputers 22. Secondary transputers exchange data with user devices and transmits directly to cell towers 61, space satellites 59 or other without going through the wireless satellite dish 28.

By means of software instructions shown in FIG. 5, with steps 47-58 as discussed above, a television remote control is instructed to reset the system or combination of transputer/television with one touch of a button to return to satellite mode when the signal is lost for any reason. This is in addition to regular functions of a remote control. A button on the transputer also accomplishes the same. The remote control has a built-in mouse that controls computer functions.

A transputer 21, 22 is designed in conjunction with environmental data delivery transmitters to download environmental data for analysis and storage.

The transputers 21, 22 and router 28b have built-in security, such that a combination of two or more of frequency range, unique addresses, system identification numbers and phones 34-43 FIG. 4 deters unauthorized access.

Each service, TV, phone, fax, video, and data may have a dedicated chip to process that particular service without interfering any other service that may be in use. From a circuit board, wires connect each processor chip to the antenna such that each chip receives a specific range of frequencies to process a different data set.

A transputer 21, 22 with five processors would have at least five data transfer wires each connected to a specific processor to speed up processing time and prevent interference of one service with another. Incoming data is flagged to distinguish it from out going data while data intended for different devices is distinguished by frequency. Flags may be a combination of binary zeros and ones.

Bits such as 00 may indicate phone data, 01 television, 10 Internet and 11 fax. Once connected, a menu is displayed for user to choose what service they want to use.

Encryption takes place when data is being beamed to space satellite 59 or cell tower 61 by service provider or at the customer transputer level as shown in steps 75-80 of FIG. 7, discussed above and decryption takes place at customer level. However, there is an option of not encrypting data at all for faster processing.

Each antenna 19, 27 has a horn with one or more wires to gather signal and direct the signal to the chip responsible for the intended service by filtering and only picking out range of frequencies intended for a particular service.

For a processor chip that has to process more that one type of service, the transputer peeks at the header of the data packet and determines by means of software instructions what kind of service to receive and what device to stream to.

Antennae 19, 27 are located in an open area where signals can easily be received. This includes top of buildings.

The dish antennae may be placed on ships, boats and other moving vessels rotates automatically to alter the direction the satellite is facing for best quality signal at all times.

Rotation is accomplished by utilizing a compass that always points to the north and a sensor to direct the dish to the desired direction

A repeater is built into the transputer 21, 22 to boost the signal so as to enable propagation of data out to cell towers 61, space satellite 59 and other transputers within a building. Routers 26 and other user devices are connected to the transputer.

The transputers 21, 22 enable recording of incoming data to external hard drives connected via ports such as HDMI. The drives are selectable at recording by aid of driver software. The hard drive can then be plugged to a computer and transfer data to other storage medium in a mode compatible with the region of operation for video. Using buttons on the remote control or transputer, transputer driver software gives options to select a drive and record in different regional playback formats such as NTSC, PAL which is changeable after recording.

The recording menu provides manual and scheduled recording through a remote control or manually on the transputer. A user can then transfer recordings to removable media such as VCD/DVD/Blue-Ray from any manufacturer and clear the drive.

The transputers 21, 22 are built with several data in/out ports to allow for multiple hard drives to be plugged into transputer to store data. Each drive may record one particular surveillance camera, locator, environmental data transmitter or video program for a prolonged recording instead of an internal drive. A user gets access to stored data remotely via the Internet by logging into an addressed transputer.

The hard drives for external data recording can be plugged into computers or similar devices after recording to transfer data to other removable storage mediums.

Data sets processed by transputers 21, 22 includes incoming television programming, incoming video/audio from surveillance cameras, incoming data from stationed transmitters such as Environmental Data Delivery and mobile transmitters such as airplane and water based vessel locators, incoming/out going fax and phone data and real time video over Internet Protocol.

A transputer 21, 22 is identified by an unique address such as Internet Protocol (IP), which facilitates connection to the Internet and enables remote administration of services offered.

The transputer 21, 22 also has an internal unique identifier. The main transputer 21, 22 is manufactured with all capabilities but secondary transputers 22 are scaled down depending on services needed. For a customer to get service, at least one of the following services has to be enabled in the transputer: Satellite based television; Wireless home phone; Wireless fax service; Real time video exchange; Surveillance camera video/audio; Transmitter capture/locators; and Computer data.

A range of frequencies is established for each type of data set as follows. Frequency ranges are symbolically represented here by alphabetical characters, but in production they are ranges represented by numerical digits. Television: aa-bb; Phone: cc-dd; Computer Data: ee-ff; Fax: gg-hh; Surveillance cameras: ii-jj; Transmitters: kk-ll; and Real time video mm-nn.

Advertisements inserted into programming are flagged to show where they start and where they end. The software enables commercial free recording by using the start and end flags of advertisements and not including them in the recording. This can be accomplished by simple software instructions such as—

while not end of selected program, record.

If advertisement beginning flag is reached,

skip recording block until end of advertisement flag.

If new block has no advertisement flag, continue recording

end.

The transputer 21, 22, enables transfer of data recorded on the built-in hard drive to other medium through ports such as video in video out and audio in audio out interfaces as well as Universal Serial Bus and High Definition Multimedia Interface.

Recording directly onto computers is enabled simply by a cable or plugging the computer in an Ethernet port on the transputer to become part of the local network.

The Transputer Mini (TM), is a small mobile device that utilizes an embedded address such as Internet Protocol (IP) to communicate with satellite and land based wireless antennas to provide wireless connectivity to a user device. The tiny TM is wirelessly upgraded and the address is changed via a wireless connection. Another version of the TM is made with a tiny keypad sunken into the surface to prevent damage to the keys. This keypad is used to enter data such as IP address. The TM is smaller than 8×4×2 centimeters and has at most 3 data ports.

The TM connects user devices such as computer and television to satellite provider wirelessly via satellite or land based wireless antennas to provide services such as Internet, television, fax and phone. It is plugged into any device with audio-video ports such as High Definition Multimedia Interface (HDMI), Universal Serial Bus (USB) and network slots to transfer data between the service provider and the devices.

On plugging the TM into a port on a device, the TM transmits its address to either satellite or land based antennas depending on configuration. The satellite beams the address to a control center which establishes a connection with the TM.

The TM is powered by ports such as USB or HDMI but may be externally powered by an electrical outlet.

The TM comprises of an antenna for radiating modulated wave coupled to a circuit board with components. The oscillation generator converts electric power into oscillations of a predetermined frequency, an amplifier increases intensity of the oscillations and the transducer converts the information to be transmitted into a varying electrical voltage proportional to each successive instantaneous intensity. A modulator is used to control variations in the oscillations intensity or provider instantaneous frequency. Some of the information sent out is Internet, fax and phone data while incoming data is all plus television, camera and transmitter data.

The antenna receives data in form of electromagnetic waves and converts it to electrical oscillations. The detection equipment demodulates and oscillators generate radio waves that can be mixed with the incoming waves.

The TM is built with full duplex radio to transmit and receive at the same time. Different frequencies are used to distinguish between types of services. One or more processor chips are used with the control logic to process TV, fax and phone data. The TM in conjunction with the interface software enables multitasking that provides one or more services concurrently. Where necessary, the TM works with an external antenna to boost connectivity.

The TM software has a Graphical User Interface viewed from a user's device screen. It enables registration of user details which on submission acquires a static address such as Internet Protocol that is used from anywhere to access services.

The TM gets its own address but when used as part of a full Transputer service, its address is associated with the main Transputer address to enable transfer of services to different locations temporarily. In such a case, one account may authenticate a stationed Transputer as well as a mobile TM connection with or without extra charges.

Each account authenticates more than one Internet address. In the database housing addresses on the authentication servers, each address column has a corresponding column with an indicator to show whether the address is transferable or not. This information is entered when a subscriber request for the kind of service. It is entered into the database via a graphical user interface at the customer service stations.

The authenticating script reads the database and determines type of connectivity an address has. Depending on terms of service, one or more addresses may be authenticated at a time.

Using a default Internet address, the TM allows download of software onto the user's equipment to enable configuration and full functionality. To download software, incoming data reads type of operating system on user's device and decides which package to install. This is accomplished by simple code such as if OS=win, install win version, if OS=Linux, install Linux version, if OS=X, install X version else if OS=other, install other version.

The default address only allows communication with provider but does not provide services. A reset using two buttons simultaneously or a hidden button, connects the device if not connected.

Once a TM is plugged into a powered computer, television or mobile device and software installed and configured, the default Internet address is replaced with a static address upon submitting configuration. The new address is linked to user details on the server. Upon plugging the Transputer Mini into a port, it automatically connects and authenticates the user. Location of device is transmitted to satellite and provided to user whenever connected but user has option to disable location.

The transputer authentication servers for Internet based users, authenticates users based on address such as IP. After authentication, a device is connected to a control server which stores tables of all server functionality and references. Depending on selection, if the user selects television, the control server directs the user to a server that runs the particular channel selected. When the user changes channel, the control server switches user device from that server to a different server that runs the new selected channel. If a user selects phone, the control server directs the user to voice over IP server and if the user selects fax, the server directs the user to a fax server.

Stationed transputers communicating with satellite are authenticated at powering on of transputers. A connection is established and data is exchanged while the connection is valid. Television data packets are identified by channels. All channels are received at once but one channel is enabled at a time with aid of the remote control or transputer button which enables channels basing on flags on the data packets. Cache memory is used to store temporary data that may be used at anytime.

Using any computer, television or mobile device and installed TM software, the TM in conjunction with the user device receives television broadcast and sends it to the display via ports such as HDMI. Another port on a TM may concurrently be used for a different data type such as telephone with an extension cable.

To disable, enable or upgrade the TM, remote administration is used via satellite on TM address, TM identification number or both.

When a TM is disabled, the TM address is flashed and the default address is enabled for use to contact provider customer service or technical support only.

Transputer servers are used to authenticate, control and provide service.

If a subscriber with an Internet connected device has broadband service from any Internet Service Provider, they get other services including television, phone and fax over the existing Internet connection.

Data source 60a, as shown in FIG. 6 represents all sources of data to satellite 59, cell tower 61, server 60b or local antenna 62. These include television data from TV stations, transmitters, surveillance cameras, water vessels and airplanes and data from Internet via cable. The Transputer servers 60b, connects to radio transmitters and receivers in an enclosure on the ground via cables. The enclosure also connects to the antennae on a tower through cables. Data is beamed to satellite for broadcast.

Transputer servers are connected to the Internet by cable 60c to send and obtain data, authenticate users and control data flow. The servers are networked with servers that receive and beams data to satellite to share the same data as it is streamed from all sources.

The servers 60b are divided into data servers, control servers and authentication severs. Each of the data servers running television programming runs only one channel. Backup and redundant servers are in the background to cover for overload for every channel.

Authentication servers hold customer details and customer device addresses as well as references to control servers. The transputer authentication servers, authenticates users based on address such as Internet Protocol (IP). After authentication, the device is connected to a control server.

Control servers store tables of all server functionality and references to data servers. Depending on selection, if a user selects television, the control server directs the user to a server that runs the particular channel selected. When the user changes channel, the control server switches user device from that server to a different server that runs the newly selected channel. If a user selects phone, the control server directs the user to voice over IP server and directed to the fax server when they choose fax.

Data servers house all current programming including television, fax and phone. Transport protocols such as User Datagram Protocol (UDP), Transmission Control Protocol (TCP) and SkyX Accelerator are used to transmit data. UDP may be used for data broadcast and multicast. One or more bits may be added to the UDP datagram or removed to make it unusable by none authenticated devices then re-added. TCP establishes a connection over the Internet Protocol before obtaining data from UDP.

Sequence numbers are provided to each UDP data packet to control flow and enable reordering at destination. A modified UDP protocol adds to data security but may not send IP headers.

Each data type uses its own port to identify source and destination and direct data stream to a particular processor and device. Packets are sent as IP datagram with an IP header, TCP header and TCP data.

The applications on transputers and TM connected devices listens to incoming data. None interactive data such as television programming may utilize the UDP protocol for faster deliver. Using flags on data packets, the application ensures packets are sorted in order and duplicates are discarded. The packets are initially stored in the cache memory and sorted before sending to destination. The sorting application reads incoming datagram while not end of program and sorts with code similar to
Flag=start, end;
Int port=JKKZ;

Receive data and check destination port (port determines type of data and destination)

Buffer data in the port's cache location
read packets in order
if start packet is read, process packets

While not end of packets in a program for port JKKZ Do
Sort and reorder using sequence number (first group in first out)
Delete duplicate
Uncompress
Remove extra bits to clean data for delivery
Cache data
Deliver to television
End

End

Next program

Interactive data and data over the Internet may use TCP to overcome Maximum Transmission Unit problems on different networks and enforce IP authentication.

Land based Internet and satellites provides the same data all the time. Users already with Internet service from other companies subscribes to other services other than Internet connectivity. They use their broadband Internet connection with a static address to get television, fax and other services without a Transputer or TM. Their address is logged in the authentication server to obtain access using any device with an operating system to which graphical interface software is downloaded.

When users switch channel on their television, they are redirected to the sever playing that particular channel based on the pseudo code similar to

While not end of channel selections in package; select channel,

if selected channel=3, switch to server running channel 3

if selected channel=4, switch to server running channel 4

if selected channel=n, switch to server running channel n; end

The system allows users to add favorite channels to a favorite folder during playback or from the main menu. A button is provided on the remote control and on the transputer to add channels to the favorites folder. A confirmation pops up and the enter button on the remote confirms addition. If a channel is already in the favorites folder, the confirmation asks to confirm deletion. To delete channels from favorites using the main menu, check boxes and scroll buttons are used for one or more deletions. Select all, inserts checkmarks in boxes against all channels in the favorites list. User is prompted to confirm before deletion.

Television programming in this system uses flags to identify data source and type of data then customize the data to a specific region using the identifying flags. For television data type, this is accomplished by simple code such as If time=2:30 pm and location=02257, pause programming in that location and insert a special type of data or advertisement. Each location name such as 02257 is defined in a table.

The present invention combines satellite, land based Internet service from multiple providers and a mobile device that provides connectivity to access television service, Internet service, voice, fax, real time video exchange, camera service and transmitters into one package for convenience. The transputer works with space satellites cell towers and land based Internet servers.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A system for distributing signals from at least one land-based service provider and at least one satellite-based service provider to multiple auxiliary devices comprising:
a wireless dish antenna for connection to a satellite or cell tower;
a wireless access point coupled to the wireless dish antenna;
a transputer coupled to the wireless access point, comprising:
a circuit board,
at least one processor on the circuit board,
an operating system for running the processor,
at least one transmitter coupled to the processor for transmitting to auxiliary devices,
at least one receiver coupled to the processor for receiving from auxiliary devices,
a repeater coupled to the processor,
a plurality of data ports coupled to the processor,
at least one hard drive coupled to the processor,
random access memory coupled to the processor, and
a plurality of network cards coupled to the plurality of data ports, including at least one network card coupled to the wireless access point to allow interaction with satellite, cell towers and/or land-based Internet
wherein the transputer further comprises a processing chip for processing and identifying signals at a plurality of frequencies, each frequency being associated with one of the multiple auxiliary user devices.

2. The system of claim 1, wherein the at least one land based service providers are Internet servers accessed through cell phone towers.

3. The system of claim 1, wherein the at least one land based service providers are Internet servers accessed through wired connections.

4. The system of claim 1, wherein the multiple auxiliary devices are a television, fax, computer, and phone.

5. (canceled)

6. The system of claim 2, wherein the Internet servers authenticate addressed auxiliary devices to access services other than the Internet.

7. A method of providing data service using a mobile transputer device comprising: a processor chip in a circuit board, a receiver and transmitter coupled to an antenna and the circuit board, memory, at least two ports and a network slot for connectivity of the mobile transputer device to a computer or television to provide Internet connectivity and other services, comprising the steps of:
connecting the mobile transputer device to a computer or television;
obtaining an initial connection through a default internet address stored within memory of the mobile transputer device to at least one satellite-based service provider or land-based service provider to obtain a usable Internet address;
authenticating the mobile transputer device to provide Internet connectivity and other services to the computer or television.

8. (canceled)

9. The method of claim 7, wherein authentication is through a usable Internet address.

10. The method of claim 7, wherein authentication is through the at least one satellite-based service provider or land-based service provider.

11. The method of claim 7, wherein the mobile transputer device further comprises a graphical user interface with buttons that link to functions within software stored within the memory and accessible both from the mobile transputer device and via the Internet from any computer by authentication.

12. The method of claim 7, wherein the mobile transputer device further comprises an address book shared by telephone and fax functions stored in the memory, the method further comprising the step of synchronizing the address book with Internet servers.

13. The method of claim 7, further comprising configuring multiple fax numbers, redirecting incoming faxes to one fax number and enabling Internet based access to the incoming faxes.

14. The method of claim 7, wherein the mobile transputer device further comprises an Internet based phone book and the method further comprising the step of connecting to the Internet based phone book.

15. The method of claim 7, further comprising sending and receiving text messages.

16. (canceled)

17. (canceled)

18. The system of claim 1, wherein one of the multiple auxiliary devices is a television and advertisements shown during television programming are based on country and region.

19. The system of claim 18, wherein a beginning and an end of each of the advertisements are indicated by flags and wherein the advertisements indicating by the flags are removed during recording.

20. (canceled)

21. The system of claim 2, wherein the Internet servers authenticate auxiliary devices through internet protocol addresses.

22. The system of claim 21, wherein authentication is based on a subscription.

23. The method of claim 9, further comprising the authentication based on a subscription.

24. The system of claim 1, wherein at least one land based service providers are Internet servers, the Internet servers comprising authentication servers, control servers, and data servers.

25. (canceled)

26. (canceled)

27. (canceled)

28. The system of claim 1, further comprising a remote control coupled to the transputer.

29. (canceled)

30. (canceled)
